(19) United States
(12) Patent Application Publication
(10) Pub. No.: US 2009/0200411 A1
(43) Pub. Date: Aug. 13, 2009

(54) Chipping knife and assembly

(76) Inventor: Bradley R. Stager, Beaverton, OR (US)

Correspondence Address: Garth Janke;PORTLAND INTELLECTUAL PROPERTY, LLC, Suite 1820, 900 SW Fifth Avenue, Portland, OR, 97204, US

(21) Appl. No.: 12/069,305

(22) Filed: Feb. 7, 2008

(51) Int. Cl. B02C 7/00

(52) U.S. Cl. 241/296

(57) ABSTRACT

A chipping knife and assembly. The knife has a front side and a spaced apart back side, the front and back sides terminating in a cutting edge so as to define an acute knife angle, the front and back sides having respective curvilinear portions for disposition between respective knife clamping members for clamping the knife, the knife having substantially constant thickness between the respective curvilinear portions. The assembly provides upper and lower clamping members shaped to fit the knife therebetween in a stable, indexed position.

### FIELD OF THE INVENTION

The present invention relates to a chipping knife and assembly for use in processing logs into lumber, chips, and flakes.

### BACKGROUND

In the use of cutting apparatus for processing logs to usable lumber, the log is forced into contact with a rotating cutting head of the apparatus that typically carries a plurality of removably clamped, elongate knives. The cutting head to which the knives are clamped typically falls into one of three classes of head shape, known in the art as disc, drum, and conical.

The apparatus spins at a relatively high rate compared to the rate of feed of the log, so that a single encounter between one of the knives of the apparatus and the log results in the displacement and removal of a relatively small portion of the log. With variations resulting from the variations in the rate of rotation relative to the rate of feed, the head geometry and the shape and configuration of the knives, this small portion is what is generally referred to in the art as a “chip” or a “flake” (hereinafter “chip”) of more or less controlled dimensions. The chip often has commercial value in itself and is not simply waste material, as it can be used in the production of manufactured wood products such as particle board.

Typically, the cutting head rotates at thousands of revolutions per minute, so each chip is removed quickly, resulting in large forces being applied to the knives. To maintain chip quality, it is important to maintain the position of the knives against these forces. So the prior art has provided numerous knife shapes, typically defined in cross-sections perpendicular to the elongate axes of the knives, that work in cooperation with the clamping members to help secure the knives. For use in disc style cutting heads, the knives are often double-sided, providing two parallel cutting edges on either side of the knife. This allows turning the knife to expose a fresh cutting edge when the exposed cutting edge becomes worn.

Schmatjen, U.S. Pat. No. 5,819,826, assigned to Key Knife, Inc. of Tualatin, Oreg., describes a double-sided knife having what have often been referred to as a pair of “deflector ridges” on the front side of the knife, i.e., the side of the knife that faces in the direction of rotation of the cutting head. The deflector ridges project from the front side of the knife and therebetween form, essentially, a keyway or channel that indexes the knife to a suitably shaped inner clamping member that receives the front side. This indexing is an example of shaping the knife in cooperation with the clamping members to stabilize the position of the knife in the apparatus, and it also provides for easy installation of the knife into proper position

Hinchliff et al., U.S. Pat. No. 7,140,408, also assigned to Key Knife, Inc., describes an alternative configuration for a double-sided knife providing for indexing. This configuration typically employs a single, centrally located deflector ridge projecting from the front side of the knife.

Indexing as a general concept is well known in the art, and most modern chipping knives provide for some form of indexing. The particular configurations employed vary widely, but a common thread most chipping knives is the manipulation of the thickness of the knife to form projections, recesses, or both. Some examples are shown in FIGS. 1-3 and discussed below.

FIG. 1 shows the cross-section of a knife 1 disclosed in Kokko et al., U.S. Pat. No. 5,649,579. The thickness of the knife is increased in the center portion of the knife to define the projection 2.

FIG. 2 shows the cross-section of a knife 3 disclosed in Derivaz, U.S. Pat. No. 4,610,285. The thickness of the knife is decreased in the center portion of the knife to define recesses 4 and 5. The recess 4 also partially defines projections 6 and 7 at which the thickness of the knife is at a maximum.

FIG. 3 shows the cross-section of a knife 8 disclosed in Svensson, U.S. Pat. No. 4,047,670. The knife defines a knife angle θ between, typically, planar surfaces 9 and 10. To define this knife angle, as in all chipping knives, the thickness of the knife necessarily decreases proceeding to the right of the line referenced as “A,” and to the left of the line referenced as “B.” However, to the left of the line referenced as A, and to the right of the line referenced as B, the thickness of the knife continues to increase, so that it is discernibly greater e.g., along the lines “C” and “D” than along the lines A and B.

A similar configuration is shown in FIG. 4, in the cross-section of the knife 11, which is indicated in the aforementioned '579 patent as being prior art to the knife 1 of FIG. 1. The knife 11 has a substantially constant cross-section, i.e., it is substantially constant everywhere except where the thickness is decreased to define the aforementioned knife angle. The '579 patent criticizes this configuration because its sharp angles create points of undesirably high stress concentration. The preferred solution taught therein is the configuration of FIG. 1. Another, partial solution would be the configuration of FIG. 3, where because of the increase in thickness to the left of the line A and to the right of the line B, the sharpness of angles φ₁ and φ₂ is correspondingly diminished.

### SUMMARY

A chipping knife and assembly. A knife according to the invention comprises a front side and a spaced apart back side, the front and back sides terminating in a cutting edge so as to define an acute knife angle, the front and back sides having respective curvilinear portions for disposition between respective knife clamping members for clamping the knife, the knife having substantially constant thickness between the respective curvilinear portions.

A knife assembly according to the invention provides upper and lower clamping members shaped to fit the knife therebetween in a stable, indexed position.

Preferably, the respective curvilinear portions define two corresponding arcs in a plane perpendicular to the cutting edge, each of the arcs having substantially continuous curvature of the same sign, wherein the arcs are circular and wherein the upper and lower clamping members are adapted to clamp the knife for use such that the lower clamping member makes substantially full contact with the knife over one of the arcs, and the upper clamping member makes no contact with the knife over substantially the entirety of the other arc.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a cross-sectional view of an elongate knife disclosed in Kokko, U.S. Pat. No. 5,649,579.

FIG. 2 is a broken, pictorial view of an elongate knife disclosed in Derivaz, U.S. Pat. No. 4,610,285.

FIG. 3 is a cross-sectional view of an elongate knife disclosed in Svensson, U.S. Pat. No. 4,047,670.

FIG. 4 is a cross-sectional view of an elongate knife indicated in Kokko, U.S. Pat. No. 5,649,579 as being prior art to the knife of FIG. 1.

FIG. 5 is a side elevation of a chipper disc incorporating a plurality of knife assemblies according to the present invention.

FIG. 6 is the detail circle referenced in FIG. 5, above, as 6-6.

FIG. 7 is an exploded pictorial view of a preferred knife assembly for use in the chipper disc of FIG. 5.

FIG. 8 is a side elevation of the knife assembly of FIG. 7, showing a lower clamping member, an elongate knife, and an upper clamping member, with the lower clamping member pivoted away from the upper clamping member, forming an open configuration of the assembly for receiving or removing the knife.

FIG. 9 is a side elevation of the knife assembly of FIG. 7, showing the lower clamping member pivoted toward the upper clamping member so as to form a closed configuration of the assembly for clamping the knife between the two clamping members.

FIG. 10 is a back-side perspective view of the knife of FIGS. 8 and 9.

FIG. 11 is a front-side perspective view of the knife of FIG. 10.

FIG. 12 is an end view of the knife of FIGS. 10 and 11.

FIG. 13 is a side elevation of a knife assembly corresponding to FIG. 8.

FIG. 14 is a side elevation of the knife assembly of FIG. 13, showing the lower clamping member pivoted into a position intermediate between the open position of FIG. 8 and the closed position of FIG. 9.

FIG. 15 is a side elevation of the knife and assembly of FIG. 13 corresponding to FIG. 9.

FIG. 16 is a magnified view of the knife and assembly of FIG. 15, showing in detail the interference between the knife and the upper and lower clamping members when the knife is clamped therebetween for use.

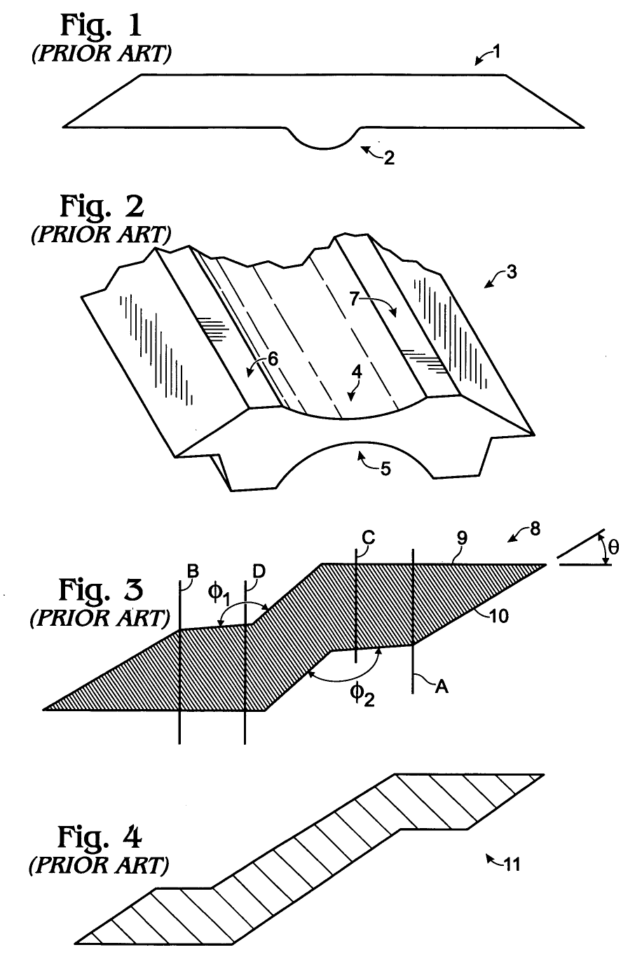

### DETAILED DESCRIPTION OF PREFERRED EMBODIMENTS

Reference will now be made in detail to specific preferred embodiments of the invention, examples of which are illustrated in the accompanying drawings. Wherever possible, the same reference numbers are used in the drawings and the description to refer to the same or like parts or dimensions.

For purposes herein, chips, flakes, and other such terms used to describe portions of logs or lumber removed by cutting apparatus as have been described above are intended to fall within the meaning of the term “chips,” where the cutting that produces these portions is referred to as “chipping,” with no loss of generality intended. Thus, it is to be understood that knives according to the invention may be used, with suitable modification, in, e.g., chipper or chipping discs, waferizers, drum chippers or flakers, ring slicers, conical chippers or canters, and any similar cutting apparatus used in the wood processing industry. Further, such knives may be used in chipping apparatus adapted for chipping materials other than wood.

Chipping knives, such as those described above, are typically cut from pre-formed bars (“pre-forms”) that are formed by hot or cold-rolling to be as close to the desired cross-sectional shape as allowed by the required tolerances. The pre-forms must be over-sized to accommodate the tolerance, and the more intricate or complex the cross-section, particularly if there are sharp angles, the greater the required tolerance. Therefore, complex shapes result in more machining and waste to finish the pre-forms into their final configuration than less complex shapes. Regardless, it has been the conventional wisdom in the art that more complex shapes, especially those with sharp corners, such as those described above are either necessary or desirable to provide the desired indexing, and so the additional cost has been deemed to be worthwhile. The present invention challenges this conventional wisdom.

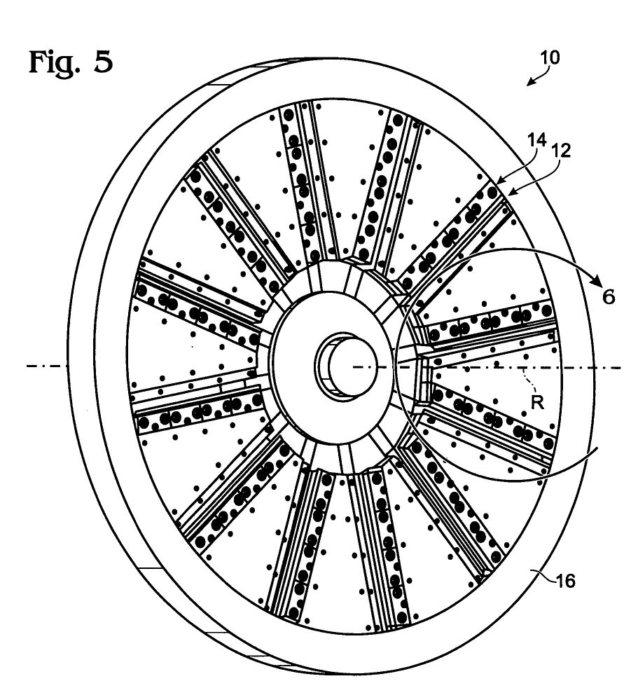

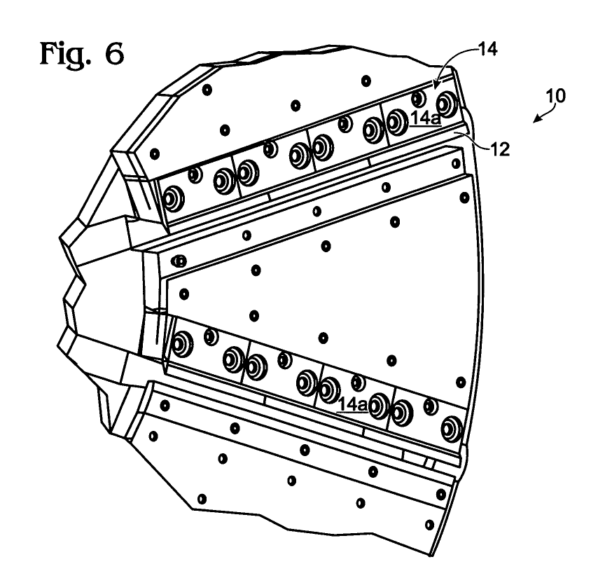

As an exemplary context for use of chipping knives according to the invention, FIGS. 5 and 6 show a disc chipper 10. On the side of the chipper 10 are a plurality of chipping knives 12 and associated clamps 14 for removably clamping the knives 12 to a cutting head 16 of the chipper 10. The cutting head 16 rotates about an axis of rotation “R,” causing each knife 12 to sweep out an annular space.

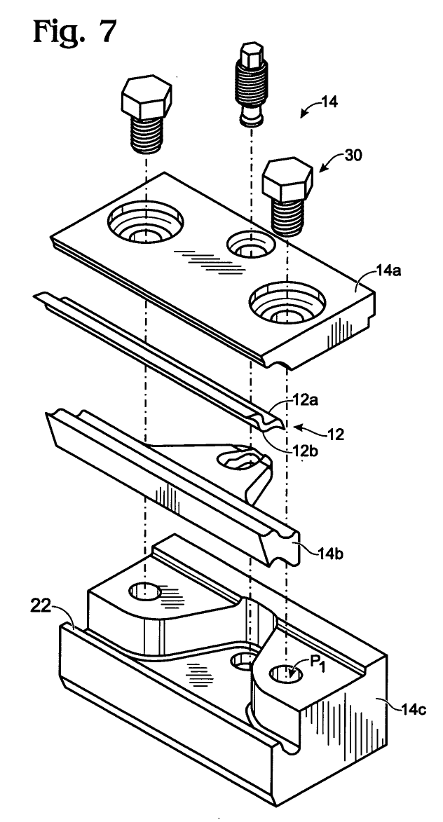

As best seen in FIG. 7, providing an exploded view of the clamps 14, the clamps 14 typically include an upper clamping member 14a and a lower clamping member 14b, the latter often referred to in the art as a “counterknife.” The upper and lower clamping members receive respective back and front sides 12a, 12b of the associated knife 12.

FIG. 7 shows a preferred embodiment for clamping the knives 12 in which each clamp 14 includes a base 14c which is bolted to the cutting head 16, and the lower clamping member 14b is disposed between the base and the upper clamping member 14a. Further, preferably, the lower clamping member 14b is adapted for pivotal adjustment about a pivot 22 of the base 14c.

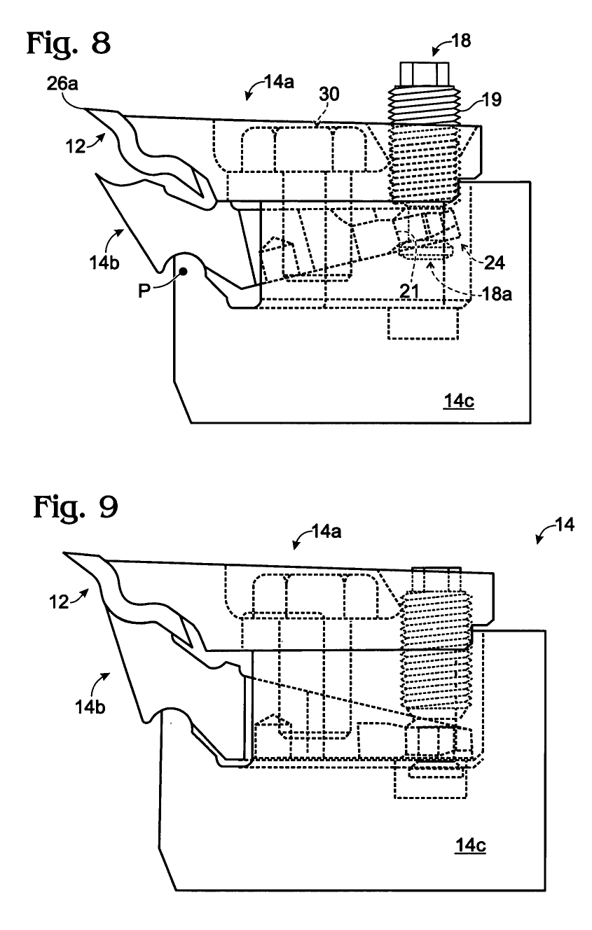

The action can be seen by comparing FIGS. 8 and 9. An adjustment bolt 18 is threadingly received in a through-hole 19 of the upper clamping member 14a, and an end 18a of the bolt is captured in a through-hole 21 of an end 24 of the lower clamping member 14b. The lower clamping member 14b is supported by the bolt 18 at the end 24, and by the base 14c at the pivot 22.

Turning the bolt 18 raises or lowers the bolt with respect to the upper clamping member 14a, taking the end 24 of the lower clamping member with it. The lower clamping member 14b thus pivots about the pivot 22 with movement of the bolt 18.

While a knife and assembly according to the invention are described in this exemplary configuration, it should be understood that the knife and assembly may be utilized in any of the three basic classes of cutting head, i.e., disc, drum, or conical, and that a pivoting clamping methodology is not required.

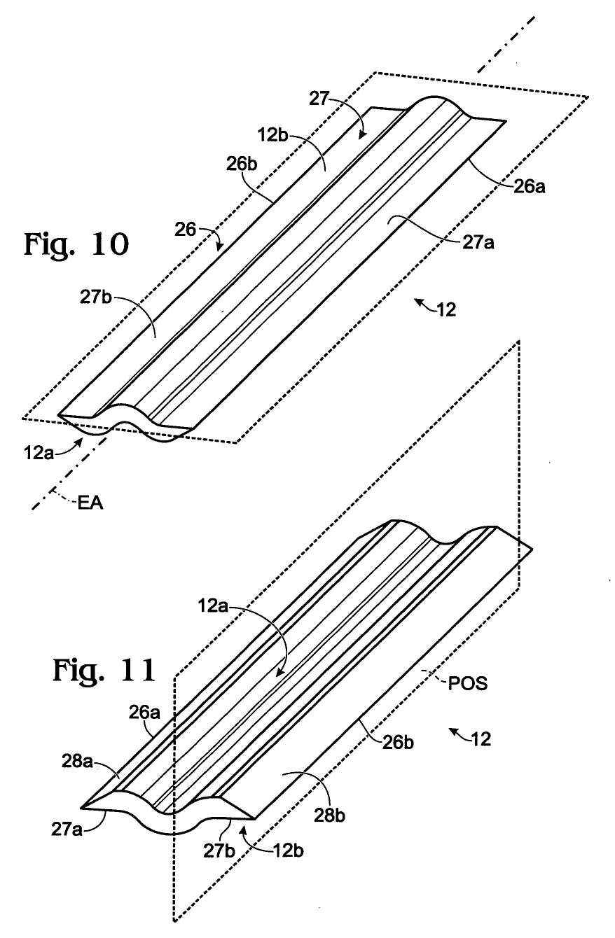

In FIG. 7, an elongate configuration of the knife 12 can be seen, the knife therefore having an elongate axis (“EA” in FIG. 10). FIGS. 8 and 9 view the knife 12 in a direction parallel to the elongate axis.

In FIG. 8 the knife 12 is clamped between the upper and lower clamping members 14a, 14b. In FIG. 9, the lower clamping member 14b has been pivoted about the pivot point 22 so as to drop the knife 12 down and away from the upper clamping member. The knife is no longer clamped, and is easily accessible and held in a convenient position for removal.

While providing the aforedescribed pivoting function is preferred, it is not essential for use of the knife 12.

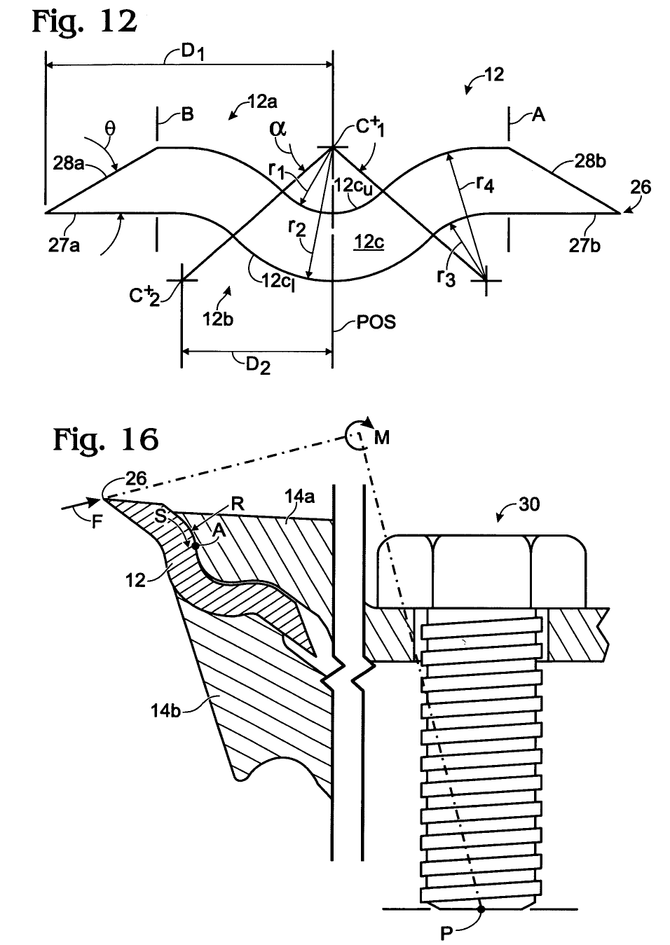

The knife 12 is shown in perspective in FIGS. 10 and 11 and in end view in FIG. 12. The knife has two parallel cutting edges 26 lying in a reference plane “A,” the edges referenced more particularly as 26a and 26b. The front side 12b includes two substantially planar knife-edge-joining portions 27, namely 27a and 27b that may also lie in the plane A, but which may be disposed at non-zero angles with respect to the plane A if desired. For example, even if the knife-edge joining portions are originally provided to lie in the plane A, these surfaces may be ground as known in the art to alter the knife angle 12.

The back side 12a of the knife has corresponding, planar knife-edge-joining portions 28, namely 28a and 28b that, along with the knife-edge-joining portions 27, define the respective knife angles θ (see FIG. 12) for the two cutting edges 26. The knife angles are preferably within the range of 20-45 degrees.

Referring to FIG. 11, the knife 12 defines a plane of reflective symmetry “POS” of the knife. The plane of reflective symmetry is perpendicular to the plane A and parallel to the elongate axis EA of the knife. With this symmetry, the knife 12 can be removed from the apparatus when it is in the configuration shown in FIG. 9, turned end-for-end to provide a fresh cutting edge, and reinstalled.

Turning to FIG. 12, the preferred embodiment of the knife 12 has a centrally located, curvilinear center section 12c. This center section 12a of the knife 12 has upper and lower surfaces 12cᵤ and 12c₁ that are parallel to maintain thickness. However, due to the curvature of these surfaces, they define locating features on both the front (12b) and back (12a) sides of the knife for locating or indexing the knife laterally (i.e., perpendicular to the plane POS) between the clamping members 14.

Preferably, the surfaces 12cᵤ and 12c₁ are circular arcs in cross-section as shown. The arcs preferably span an angle α of at least 30 degrees, preferably at least 60 degrees, and most preferably greater than 90 degrees (96 degrees is shown). If the curvilinear surfaces 12cᵤ and 12c₁ define other than circular arcs, the dimensions of the corresponding central section is nevertheless preferably similar.

In their circular configuration, the surfaces 12cᵤ and 12c₁ differ in their radii of curvature “r₁” and “r₂” measured from the same center. The difference r₁-r₂ is the thickness of the knife, which is substantially constant for the knife everywhere except to the right of the line “A” and to the left of the line “B” where the knife thickness decreases for the purpose of defining the knife angles θ.

The location of the center of curvature relative to the surfaces 12cᵤ and 12c₁ defines whether the sign of the curvature, i.e., whether the curvature is positive or negative. For a center of curvature C⁺₁ as shown in FIG. 12, the curvature is arbitrarily defined for purposes herein as being positive because it is above the surfaces (relative to the orientation of FIG. 12, which is also arbitrary), so that a center of curvature below the surfaces would define negative curvature. A circular arc has a single radius of curvature. It should also be understood that any curvilinear line or arc can be defined by a series or sequence of circular arcs with centers of curvature spaced arbitrarily close together. Therefore, a non-circular arc may be defined by an unbroken or continuous sequence of circular arcs. Further, if all of these circular arcs have centers of curvature of the same sign, then the arc can be considered to have a curvature of a single sign. The surfaces 12cᵤ and 12c₁ as shown in FIG. 12 could be replaced with a non-circular arc having a curvature of a single sign without departing from the principles of the invention.

An outstanding advantage of the configuration of the knife 12 is that the curvilinear surfaces 12cᵤ and 12c₁ essentially eliminate stress concentration while continuing to provide the desired indexing. Moreover, the substantially constant thickness of the knife makes it relatively easy to manufacture, utilizing a minimum amount of material and a minimum number of forming operations.

Preferably, the knife cross-section is further defined by curvilinear portions on either side of the center section 12c. In the case of a symmetrical knife, these are defined by a center of curvature C⁺₂ and a set of radii “r₃” and “r₄” extending therefrom where, again, the difference between the radii is the thickness of the knife. A line drawn between the centers of curvature C⁺, and C⁺₂ defines a corresponding side of the spanning angle α discussed above. In the preferred embodiment shown, dimensions “D₁” and “D₂” are 0.840″ and 0.447″ respectively, r₁=r₃=0.200″, and r₂=r₄=0.400″ where FIG. 12 is drawn to scale.

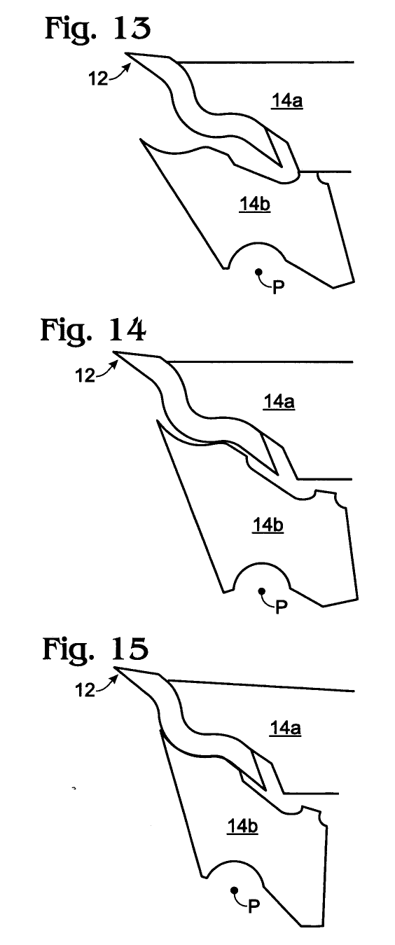

FIGS. 13-15 illustrate stages of the process of clamping the knife 12 between the clamping members 14. More particularly, FIG. 13 shows the lower clamping member 14b pivoted away from the upper clamping member 14a (pivot center-point “P”), forming an open configuration of the assembly for receiving or removing the knife 12 (also shown in FIG. 8); FIG. 15 shows the lower clamping member pivoted toward the upper clamping member so as to form a closed configuration of the assembly, for clamping the knife between the two clamping members (also shown in FIG. 9); and intermediate FIG. 14 shows the lower clamping member pivoted so as to form a configuration that is intermediate to the open and closed configurations.

FIG. 16 shows in more detail the manner in which the knife 12 mates with the upper and lower clamping members in the closed configuration of FIG. 15. Particularly, moving in the direction of the arrow “S,” there is a transition at approximately the point referenced as “A” (at about the end of the surface 12cᵤ) from full contact between the knife 12 and the upper clamping member 14a to a very slight gap of between about 0.001-0.005″ between these parts.

In this, closed configuration, bolts 30 (see also FIG. 7) hold the upper clamping member 14a in place so as to resist forces “F” applied to the cutting edge 26 of the knife 12. The forces F produce a moment “M” about points “P₁” where the bolts connect to the base 14c (see also FIG. 7). The aforementioned gap ensures that the resistive force “R” is applied by the lower clamping member at locations thereon at which maximum mechanical advantage is obtained, while still providing for indexing and consequent lateral stability of the knife to within an acceptably small tolerance.

As indicated in FIG. 16, the lower clamping member 14b preferably mates to the knife 12 such that over at least the surface 12c₁ there is substantially full contact.

It is to be understood that, while a specific knife and assembly has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A knife, comprising a front side and a spaced apart back side, said front and back sides terminating in a cutting edge so as to define an acute knife angle, said front and back sides having respective curvilinear portions for disposition between respective knife clamping members for clamping the knife, the knife having substantially constant thickness between the respective curvilinear portions.

2. The knife of claim 2, wherein said knife angle is greater than zero and less than about 45 degrees.

3. The knife of claim 2, wherein at least one said front side and said back side includes a planar portion for terminating in said cutting edge and at least partially defining said knife angle.

4. The knife of claim 2, wherein said respective curvilinear portions define two corresponding arcs in a plane perpendicular to said cutting edge, each of said arcs having substantially continuous curvature of the same sign.

5. The knife of claim 4, wherein said arcs are circular.

6. The knife of claim 5, wherein said circular arcs extend over a range of at least about 60 degrees.

7. The knife of claim 2, said front and back sides terminating in two cutting edges at opposite ends of the knife, said cutting edges being linear, parallel and lying in a reference plane, said front and back sides defining substantially identical, acute knife angles at each of said cutting edges, the knife having mirror image symmetry about a plane of symmetry perpendicular to said cutting edges and said reference plane.

8. The knife of claim 7, wherein two of said curvilinear portions define two corresponding arcs in a plane perpendicular to said cutting edges, each of said arcs having substantially continuous curvature of the same sign.

9. The knife of claim 8, wherein said arcs are centered on said plane of symmetry.

10. The knife of claim 9, wherein said arcs are circular and extend over a range of at least about 60 degrees.

11. The knife of claim 8, wherein said arcs are circular and extend over a range of at least about 60 degrees.

12. The knife of claim 8, wherein at least one said front side and said back side includes respective first planar portions for terminating in the respective said cutting edges and at least partially defining the respective said knife angles.

13. The knife of claim 12, wherein said first planar portions are part of said front side and lie in said cutting plane.

14. The knife of claim 13, wherein said back side includes respective second planar portions for terminating in the respective said cutting edges and, together with said first planar portions, fully defining the respective said knife angles.

15. The knife of claim 14, wherein the curvatures of said arcs are positive.

16. The knife of claim 13, wherein the curvatures of said arcs are positive.

17. The knife of claim 16, wherein said arcs are centered on said plane of symmetry.

18. The knife of claim 17, wherein said arcs are circular and extend over a range of at least about 60 degrees.

19. The knife of claim 16, wherein said arcs are circular and extend over a range of at least about 60 degrees.

20. The knife of claim 2, wherein said cutting edge is linear.

21. A knife assembly, comprising:
a knife, comprising a front side and a spaced apart back side, said front and back sides terminating in a cutting edge so as to define an acute knife angle, said front and back sides having respective curvilinear portions for disposition between respective knife clamping members for clamping the knife, the knife having substantially constant thickness between the respective curvilinear portions;
an upper clamping member; and
a lower clamping member, said upper and lower clamping members shaped substantially to fit said knife therebetween in a stable, indexed position.

22. The knife assembly of claim 21, wherein said respective curvilinear portions define two corresponding arcs in a plane perpendicular to said cutting edge, each of said arcs having substantially continuous curvature of the same sign, wherein said arcs are circular and extend over a range of at least about 60 degrees, and wherein said upper and lower clamping members are adapted to clamp the knife for use such that said lower clamping member makes substantially full contact with the knife over one of said arcs, and said upper clamping member makes no contact with the knife over substantially the entirety of the other of said arcs.

23. The knife assembly of claim 23, said front and back sides of said knife terminating in two cutting edges at opposite ends thereof, said cutting edges being parallel and lying in a reference plane, said front and back sides defining substantially identical, acute knife angles at each of said cutting edges, the knife having mirror image symmetry about a plane of symmetry perpendicular to said cutting edges and said reference plane.

24. The knife assembly of claim 23, wherein said cutting edges are linear.
